(19) United States
(12) Patent Application Publication
(10) Pub. No.: US 2026/0154716 A1
(43) Pub. Date: Jun. 4, 2026

(54) Integrated Marketplace and Bidding Platform with Dynamic Fulfillment Allocation

(71) Applicants: Brayard Daniel Gordon, JR., Bronx, NY (US); Brayard Daniel Gordon, SR., CORAL SPRINGS, FL (US)

(72) Inventors: Brayard Daniel Gordon, JR., Bronx, NY (US); Brayard Daniel Gordon, SR., CORAL SPRINGS, FL (US)

(21) Appl. No.: 18/967,355

(22) Filed: Dec. 3, 2024

(51) Int. Cl. G06Q 30/0283; G06Q 10/0833; G06Q 20/06; G06Q 20/38

(52) U.S. Cl. CPC G06Q 30/0284; G06Q 10/0833; G06Q 20/06; G06Q 20/389

(57) ABSTRACT

A system and method for deploying and monitoring robotic services for events and delivery operations, comprising receiving a service request via a computing device or cloud-based system, wherein the request includes event-specific details. The system generates a list of available robots using an AI-based algorithm, provides options for customizing selected robots, and calculates a dynamic service price. Logistics are scheduled and coordinated to ensure timely deployment via GPS tracking and optimized routes. Robot performance is monitored during operations using AI-driven analytics, with troubleshooting and maintenance to prevent failures. Post-event feedback is collected and analyzed to refine future services. Operational data is stored and used to improve robot performance. Blockchain-based smart contracts enforce service agreements, enabling secure and automated job placements.

### FIELD OF THE INVENTION

The present invention generally relates to systems and methods for improving robotic delivery technologies and operations. More particularly, the present invention focuses on enhancing the efficiency, security, and reliability of robotic delivery services through the use of secure transactions, ownership verification, and smart contract execution. Additionally, the invention pertains to the application of blockchain technology for robotic asset management, integrating digital identity verification and asset tokenization to enable secure, transparent, and optimized deployment of robotic delivery systems for private and commercial events.

### BACKGROUND OF THE INVENTION

The use of robotic delivery services has grown significantly in recent years, driven by advancements in artificial intelligence (AI), machine learning, and robotics technology. Robots are increasingly being utilized for both private and commercial applications, including event-based services. However, despite this growth, several challenges remain that limit the efficiency, security, and reliability of robotic delivery systems, particularly in the context of interactive and customizable services for events. Traditional online delivery platforms, such as Uber, DoorDash, and other similar services, have revolutionized the logistics and delivery industry by providing on-demand services through centralized platforms. While these systems have proven effective for human-operated delivery, they face several drawbacks when applied to robotic delivery systems. For example, these platforms rely heavily on centralized control, which can create vulnerabilities such as single points of failure, data breaches, and inefficiencies in scaling operations. Additionally, these systems lack the ability to securely manage autonomous robotic assets, verify ownership, or execute smart contracts for automated transactions. This creates challenges in ensuring trust, transparency, and accountability in robotic delivery operations.

Moreover, as robotic delivery systems become more advanced, there is a growing interest in leasing or renting robots for business purposes, similar to the rental car business model. For example, businesses or individuals may lease robots to provide delivery services, event support, or other commercial applications. However, this introduces additional challenges, as secure systems are required to manage ownership verification, usage tracking, and payment processing. Without secure transaction mechanisms and ownership verification, leasing robotic assets becomes risky, as there is potential for unauthorized use, disputes over ownership, and lack of accountability for damages or misuse. Current systems do not provide the necessary infrastructure to support such leasing models, further limiting the scalability and adoption of robotic delivery technologies.

Additionally, existing solutions for event-based robotic services are underdeveloped. Event organizers often require highly customizable and interactive solutions tailored to specific themes or logistical needs. Current systems do not provide the flexibility to configure robotic services for such specialized applications, nor do they offer real-time monitoring and performance optimization for robots deployed in dynamic environments like events or parties. These limitations hinder the adoption of robotic delivery systems for applications that demand both reliability and adaptability.

The lack of secure frameworks for managing robotic operations exacerbates these challenges. Current robotic delivery solutions often fail to address critical concerns such as secure transactions, ownership verification, and the execution of smart contracts. Without these capabilities, robotic systems remain vulnerable to unauthorized access, data breaches, and inefficiencies in service delivery. The absence of robust mechanisms for verifying digital identities and managing robotic assets further complicates the deployment of robots in both private and commercial settings.

Accordingly, there is a need for a solution that overcomes the limitations of traditional online delivery platforms and enhances the efficiency, security, and reliability of robotic delivery services. Such a solution must integrate secure transaction processing, ownership verification, and smart contract execution while addressing the specific demands of event-based robotic services and leasing models. By incorporating advanced technologies such as blockchain for robotic asset management, digital identity verification, and real-time performance monitoring, the present invention provides a comprehensive platform to meet these needs. This invention aims to deliver a seamless, secure, and engaging experience for event organizers, attendees, and businesses leasing robotic assets, addressing the shortcomings of existing systems and paving the way for the next generation of robotic delivery technologies.

The present invention is intended to solve the problems associated with conventional devices and methods and provide improvements on these devices.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present invention provides a system and method for offering on-demand robotic delivery services specifically designed for events and parties. This invention enables users to select, customize, and deploy robots for various purposes through an intuitive and user-friendly platform, ensuring a seamless and interactive experience for event organizers and attendees.

A key aspect of the invention is the development of a curated service catalog featuring a wide selection of robots, including humanoid robots, drones, and service robots. These robots can be customized with features such as speech modules, visual displays, and interactive behaviors to suit specific event needs. The invention also includes a booking platform, accessible via mobile and web interfaces, that allows users to browse available robots and book them using a real-time availability calendar.

To further enhance the user experience, the system offers extensive customization options. Users can configure robot appearances, program specific messages, and design performance routines tailored to the details of their event.

The present invention also incorporates a dynamic pricing model, which adjusts pricing based on factors such as duration, level of customization, and demand. Secure payment gateways are integrated into the platform to ensure safe and reliable transactions.

The present invention handles the logistics and deployment of the robots, including scheduling, delivery, and setup. Real-time tracking and on-site support are provided to ensure smooth operations. During the events, the system monitors robot performance to maintain optimal operation, offering both remote and on-site support services as needed.

After the event, the system collects user feedback and analyzes data to improve future service offerings. This post-event feedback loop helps refine the platform, integrate new technologies, and continuously enhance the overall experience for users. This invention focuses on the technological methods and systems that enable the seamless delivery and customization of robotic services. By addressing the unique demands of event-based applications, it ensures a dynamic, interactive, and engaging experience for all parties involved.

### BRIEF DESCRIPTION OF THE DRAWINGS

FIG. 1 is an illustration of an online platform consistent with various embodiments of the present disclosure.

FIG. 2 is a block diagram of a system, in accordance with some embodiments.

FIG. 3 is an illustration of one embodiment of a method of the present invention.

FIG. 4 is an illustration of one embodiment of a system of the present invention.

FIG. 5 is an illustration of an alternative embodiment of the method of the present invention.

FIG. 6 is an illustration of one embodiment of the step of deploying robots of the present invention.

FIG. 7 is an illustration of one exemplary usage scenario of the present invention.

FIG. 8 is an illustration of one exemplary use scenario for smart contracts of the present invention.

FIG. 9 is an illustration showing a dynamic process for multiple inputs of the present invention.

FIG. 10 is an illustration of one exemplary use scenario for renting robots of the present invention.

FIG. 11 is a block diagram of a computing device for implementing the methods disclosed herein, in accordance with some embodiments.

### DETAIL DESCRIPTIONS OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing herefrom, which scope is to be defined by the claims and the equivalents thereof. It is not intended that the scope of patent protection be defined by reading into any claim limitation found herein and/or issuing herefrom that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing herefrom. The present disclosure contains headers. It should be understood that these headers are used as references and are not to be construed as limiting upon the subject matter disclosed under the header.

The present disclosure includes many aspects and features. Moreover, while many aspects and features relate to, and are described in the context of methods, systems, apparatuses, and devices for offering on-demand robotic delivery services for events and parties, embodiments of the present disclosure are not limited to use only in this context. For example, the disclosed systems and methods may also be applied to other industries or applications requiring secure, customizable, and efficient robotic services, such as logistics, healthcare, or retail. The invention provides a flexible and scalable platform that can be adapted to meet the needs of various industries, ensuring broad applicability and utility.

In general, the method disclosed herein may be performed by one or more computing devices configured to execute the necessary steps of the invention. In some embodiments, the method may be carried out by a server computer in communication with one or more client devices over a communication network, such as the Internet. Alternatively, the method may involve a combination of various devices, including at least one server computer, client device, network device, sensor, and actuator. Examples of client devices and server computers include, but are not limited to, desktop computers, laptops, tablets, smartphones, wearable devices, Internet of Things (IoT) devices, smart appliances, video game consoles, and high-performance systems such as rack servers, supercomputers, or quantum computers. These devices may execute software applications, such as operating systems (e.g., Windows, Mac OS, Linux, Android), to provide user interfaces (e.g., graphical, touch-based, voice-based, or gesture-based) and network interfaces for communication with other devices.

The server computer may include a processing device configured to perform various data processing tasks, such as analyzing, identifying, determining, generating, transforming, encrypting, decrypting, compressing, decompressing, and more. Additionally, the server computer may include a communication device to facilitate interaction with external devices, such as client devices, databases (public, private, or third-party), and other network entities. Communication may occur over wired or wireless channels, and the server's communication device may support transmitting and receiving information in electronic form.

Furthermore, the server computer may include a storage device designed for reliable digital data storage and retrieval. Storage technologies may incorporate features such as data compression, backup, redundancy, deduplication, error correction, and role-based access control to ensure secure and efficient storage.

The disclosed method may involve steps that are initiated, maintained, controlled, or terminated based on input from devices operated by users. These users may include end users, administrators, or other relevant parties. The term “user” may refer to a human, an animal, or an artificially intelligent entity, depending on the context of the invention.

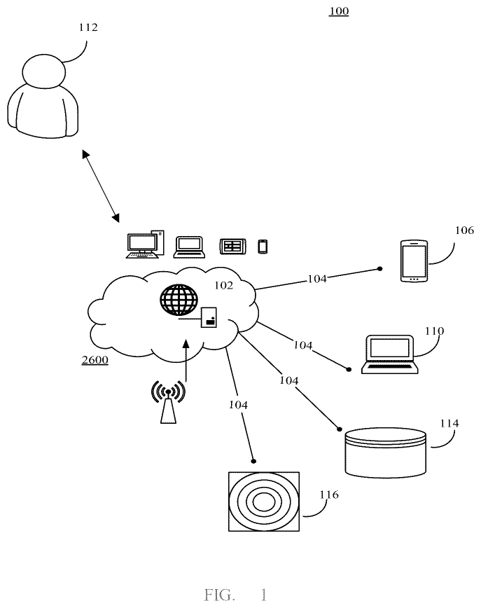

FIG. 1 illustrates an example of an online platform 100 consistent with the embodiments of the present disclosure. The platform 100 may be hosted on a centralized server 102, such as a cloud computing service, and may communicate with various network entities, including mobile devices 106 (e.g., smartphones, tablets, laptops), other electronic devices 110 (e.g., desktop computers, server computers), databases 114, and sensors 116 via a communication network 104, such as the Internet.

The databases 114 may include those associated with government agencies or private entities. Users of the platform, such as end-users, administrators, service providers, and service consumers, may access the platform through web-based software applications or browsers. These applications may take the form of websites, web applications, desktop applications, or mobile applications compatible with various computing devices. The platform 100 may also include a distributed architecture, where certain components, such as federated learning models or IoT data processing modules, are deployed across edge devices or local servers to enhance scalability, reduce latency, and ensure data privacy.

In one embodiment, the platform 100 integrates an AI-based hybrid algorithm to optimize service delivery by matching user preferences and task requirements with available robots or service providers. Collaborative filtering modules (or processes) within the platform may be configured to analyze historical user data, while content-based filtering modules (or processes) can be configured to evaluate the capabilities of robots or service providers, such as task compatibility, battery life, or environmental adaptability. These modules may operate in real-time to generate dynamic recommendations for users.

Additionally, in some embodiments, the platform 100 may incorporate a secure transaction mechanism that leverages blockchain technology to ensure tamper-proof logging of service requests and transactions. This mechanism may utilize cryptographic hashes to verify the integrity of data and Advanced Encryption Standard (AES) protocols to secure sensitive information during transmission.

In some embodiments, the platform 100 may further includes a self-learning anomaly detection model that continuously monitors operational data from IoT sensors 116 to identify and address anomalies in real-time. This model may use reinforcement learning techniques to adapt to changing conditions, such as variations in robot performance or environmental factors, ensuring reliable service delivery. Federated learning AI frameworks can also be integrated into the platform 100, in some embodiments, to enable distributed training of machine learning models across multiple datasets stored on different devices or systems. This approach ensures compliance with data privacy regulations by avoiding the need to centralize raw data while still allowing the platform to refine its predictive models, such as those used for dynamic pricing or anomaly detection.

The platform 100 may also include a custom NLP model trained on user feedback, such as textual reviews and sentiment data, to analyze user satisfaction and identify trends in service performance. This model may provide actionable insights to administrators or service providers, enabling continuous improvement of the platform's offerings.

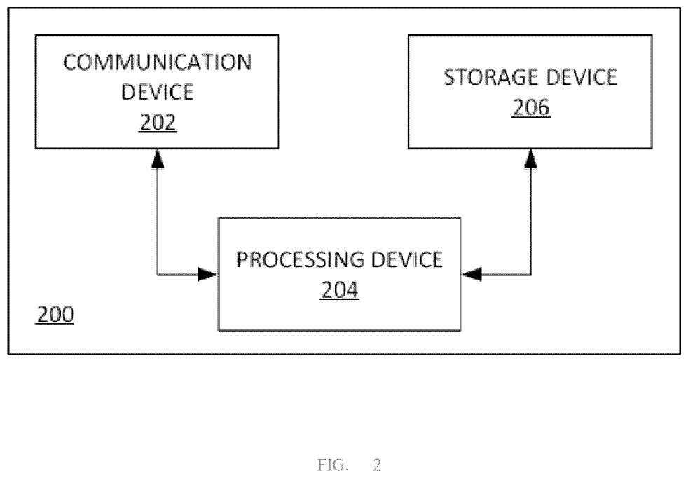

FIG. 2 provides a block diagram of a system 200 in accordance with the disclosed embodiments. The system 200 includes key components such as a communication device 202, a processing device 204, and a storage device 206, which collectively enable the functionality of the platform described herein.

The communication device 202 is configured to facilitate interaction between the system and various network entities, including user devices such as smartphones, tablets, desktops, laptops, and other computing devices. It enables seamless data exchange over a communication network, such as the Internet, using protocols like HTTP, HTTPS, or WebSocket for real-time communication. The communication device 202 may also interface with IoT sensors and edge devices to collect operational data, such as robot performance metrics or environmental conditions, ensuring the system remains responsive to real-time inputs.

The processing device 204 is responsible for executing tasks and performing data processing operations critical to the system's functionality. This includes running machine learning algorithms, such as the AI-based hybrid algorithm for matching user preferences with robot capabilities, the self-learning anomaly detection model for identifying operational anomalies, and the federated learning framework for distributed model training. The processing device 204 may include one or more CPUs, GPUs, or specialized AI accelerators to handle computationally intensive tasks, such as training and inference for the custom NLP model or reinforcement learning models.

The storage device 206 ensures secure and reliable storage and retrieval of digital information necessary for the operation of the system. This includes storing user data, historical transaction logs, robot performance metrics, and training datasets for machine learning models. In some embodiments, the storage device 206 may also include a blockchain ledger to securely log service requests and transactions, ensuring data integrity and traceability. Additionally, the storage device 206 may support distributed storage architectures to facilitate data privacy and compliance with regulations by keeping sensitive data localized while enabling federated learning.

The disclosed system and method leverage a combination of computing devices, communication networks, and software technologies to enable seamless operation. The architecture ensures secure data processing, reliable communication, and efficient storage, making it suitable for a wide range of applications, including robotic delivery services, event management, and other use cases requiring robust and scalable solutions.

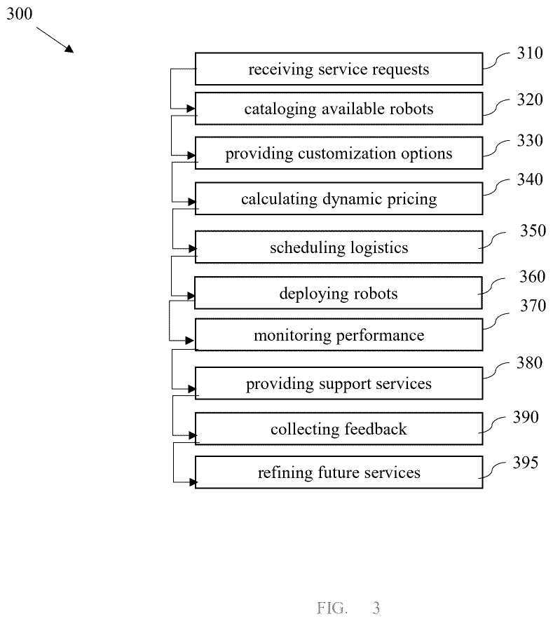

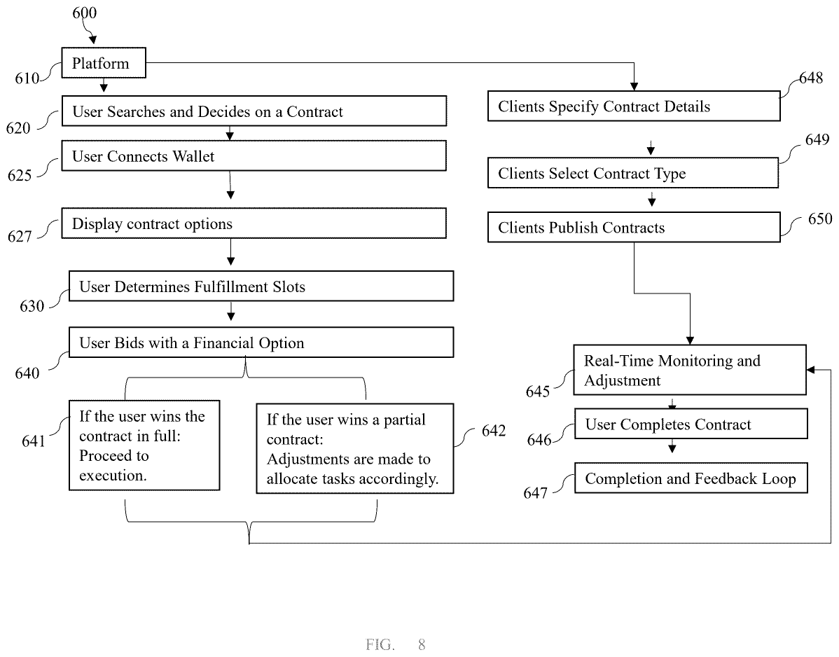

The present invention, as shown in FIGS. 3-10, provides a method 300 and system 400 for delivering on-demand robotic services for events and parties, as well as facilitating processes supporting delivery robot leasing.

As shown in FIG. 3, the method 300 may include receiving service requests 310, cataloging available robots 320, providing customization options 330, calculating dynamic pricing 340, scheduling 350 and deploying robots 360, monitoring performance 370, providing support services 380, collecting feedback 390, and refining future services through AI-driven analytics 395.

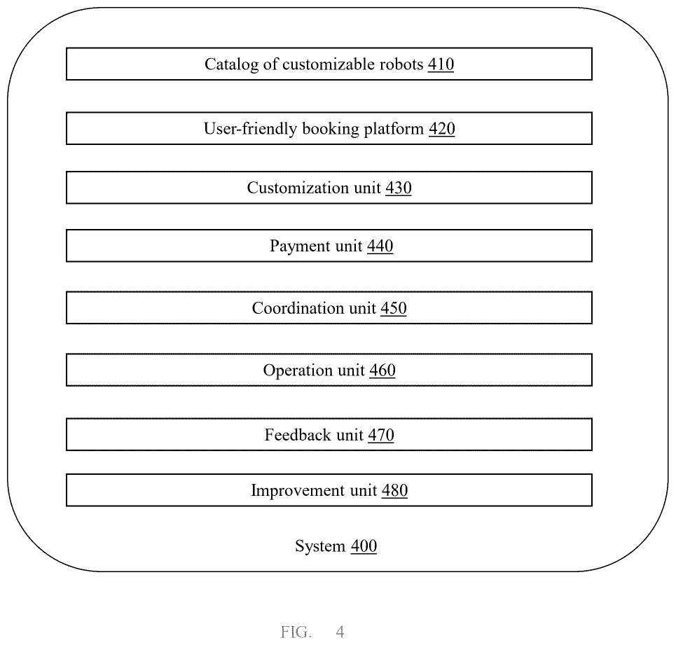

As shown in FIG. 4, the system 400 supporting this method 300 may comprise a catalog of customizable robots 410, a user-friendly booking platform 420, event-specific customization tools 430, a dynamic pricing and secure payment model 440, logistics and deployment coordination infrastructure 450, event execution and monitoring tools 460, and post-event feedback mechanisms 470.

Together, the method 300 and system 400 enable seamless, efficient, and interactive robotic services for events and delivery operations, incorporating advanced technologies such as blockchain, AI, IoT, and predictive analytics.

In one embodiment, as described above, the present invention provides a method 300 for delivering robotic services for events and delivery operations, comprising the following steps:

### Receiving Service Requests 310

The present invention can be configured to receive a service request from a user for robotic services at events or delivery operations. This process may include secure transactions, ownership verification, and smart contract execution for private and commercial events. In one embodiment, the method 300 may include a step of receiving, via a computing device or cloud-based system, a service request from a user for robotic services at events or delivery operations, wherein the service request includes details such as event type, location, duration, and specific robot requirements.

Events and delivery operations often require precise and secure communication of service requirements to ensure the correct deployment of robots. Without secure mechanisms, service requests may be intercepted, altered, or misused, leading to operational inefficiencies or security breaches. For example, a malicious actor could intercept a service request and modify the robot's deployment location, causing delays or misuse of resources.

Thus, in some embodiments, the service request is processed through a secure transaction mechanism, wherein the methos may ensure the integrity and confidentiality of the request using encryption protocols such as Advanced Encryption Standard (AES) or Transport Layer Security (TLS).

The inclusion of encryption protocols such as AES or TLS ensures that the service request is transmitted securely, preventing unauthorized access or tampering. This improves the reliability and security of the system compared to traditional unencrypted communication methods. By leveraging cloud-based systems, the method enables scalability and real-time processing of service requests, which is particularly beneficial for large-scale events or operations requiring multiple robots.

The ability to handle detailed service requests (e.g., specifying robot capabilities or event-specific requirements) ensures a higher degree of customization, which is a unique improvement over generic robotic service systems.

Robotic services often involve multiple stakeholders, including service providers, event organizers, and robot owners. Traditional centralized systems for managing robotic assets and service agreements are prone to single points of failure, tampering, or disputes over service terms. For example, disputes may arise if a robot fails to perform as agreed, and there is no immutable record of the service agreement or performance metrics.

Thus, in some embodiments, the method 300 may further comprise integrating blockchain technology for robotic asset management, wherein the blockchain ledger records and verifies transactions related to robot deployment, ownership, and service history. The blockchain ledger may utilize a distributed consensus mechanism, such as Proof of Stake (PoS) or Proof of Authority (PoA), to ensure tamper-proof and transparent transaction records. In one embodiment, the blockchain ledger stores cryptographic hashes of service agreements, ensuring immutability and traceability of robotic service contracts. Blockchain integration ensures that all transactions and agreements are recorded in a tamper-proof and transparent manner, reducing the likelihood of disputes and improving trust among stakeholders. The use of distributed consensus mechanisms (e.g., PoS or PoA) eliminates the need for a central authority, enhancing the system's resilience to failures or attacks. Storing cryptographic hashes of service agreements on the blockchain ensures that the terms of the agreement cannot be altered retroactively, providing a unique technical improvement over traditional contract management systems. This feature also enables automated auditing and compliance checks, which are critical for large-scale deployments or regulated industries.

Robotic services often require secure verification of user identity and robot ownership to prevent unauthorized access or misuse. For example, a malicious actor could impersonate a legitimate user to gain control of a robot or disrupt operations.

Tokenizing robotic assets ensures that each robot is uniquely identifiable and traceable, which is critical for managing large fleets of robots or ensuring compliance with service agreements. Thus, in a preferred embodiment, the method 300 includes securely verifying user identity and robot ownership using a digital identity verification system. The system may employ multi-factor authentication (MFA), biometric verification (e.g., facial recognition or fingerprint scanning), or public key infrastructure (PKI) to authenticate users.

The method 300 may further comprise tokenizing robotic assets, wherein each robot is represented as a unique digital token on the blockchain. The token may include metadata such as robot specifications, ownership details, and service capabilities.

In some embodiments, the system 400 enables smart contract execution for robotic job placement and service bidding. The smart contracts, implemented using blockchain platforms such as Ethereum or Hyperledger, automatically enforce terms and conditions of the service agreement, including payment disbursement, service duration, and robot performance metrics. The use of MFA, biometric verification, or PKI provides a robust and secure method for verifying user identity, reducing the risk of unauthorized access compared to traditional username/password systems. Tokenizing robotic assets on the blockchain ensures that each robot has a unique digital representation, enabling precise tracking and management of robotic resources. This is a significant improvement over traditional asset management systems, which may rely on centralized databases prone to errors or tampering.

Smart contract execution automates the enforcement of service agreements, reducing the need for manual intervention and minimizing the risk of disputes. For example, a smart contract could automatically release payment to the service provider once the robot completes its task, ensuring transparency and efficiency. The inclusion of metadata in the digital token (e.g., robot specifications, ownership details) enables advanced functionalities such as automated matching of robots to service requests based on their capabilities, which is a unique technical improvement over generic robotic service systems.

### Cataloging Available Robots 320

In one embodiment, the method 300 generates a list, catalog, or inventory of available robots using an AI-based hybrid algorithm. In some embodiments, the method 300 may combine collaborative filtering (based on user preferences) and content-based filtering (based on robot capabilities) to match robots to event or job requirements. In a preferred embodiment, the method 300 ensures efficient matching of robots to user needs, improving satisfaction and operational efficiency.

### Providing Customization Options 330

In one embodiment, the method 300 provides users with options to customize robots for specific events or job requirements. In some embodiments, reinforcement learning and continuous learning may be used to refine robot configuration suggestions based on user preferences and event/job types. In a preferred embodiment, users may configure robot appearances, behaviors, and performance routines using intuitive tools.

### Calculating Dynamic Pricing 340

In one embodiment, the method 300 calculates a dynamic price for the requested service using an AI-based pricing algorithm. In some embodiments, the algorithm analyzes factors such as duration, customization level, demand, and historical pricing data. In a preferred embodiment, predictive analytics may be used to ensure competitive and fair pricing by forecasting demand and usage patterns.

### Scheduling Logistics 350

In one embodiment, the method 300 schedules and coordinates logistics for deploying robots to event locations or job sites. In some embodiments, GPS tracking ensures timely delivery of robots. In a preferred embodiment, the system coordinates with IoT-connected infrastructure for seamless deployment.

### Deploying Robots 360

In one embodiment, the method 300 includes a step to deploy the selected robots to the event location or job site, leveraging advanced technical improvements to enhance the deployment process.

The method 300 and system 400 may include a GPS system and an environmental data tracking system, or similar technologies, to utilize GPS data and real-time environmental data to optimize deployment routes, ensuring efficient navigation and operational readiness upon arrival.

To achieve this, the system 400 may employ a plurality of sensors (advanced multi-sensor technologies, such as LiDAR, cameras, and ultrasonic sensors), to continuously scan the environment and detect irregular ground surfaces, obstacles, or hazards like potholes, debris, or steep inclines. These sensors generate a 3D map of the surroundings, enabling the robot to dynamically adjust its route or movement to avoid hazards and ensure safe navigation. Additionally, real-time traffic and terrain data are integrated into the route optimization process to further enhance efficiency.

Thus in some embodiments, the method 300 may include dynamically determining and executing a deployment route for a robot by utilizing GPS data and real-time environmental data to establish an initial route, continuously scanning the environment during deployment using multi-sensor technologies to detect irregular ground surfaces, obstacles, or hazards, generating a three-dimensional (3D) map of the surroundings based on the sensor data to identify navigational hazards in real-time, and dynamically adjusting the route based on the detected hazards while integrating real-time traffic and terrain data to ensure safe and efficient navigation, thereby enabling the robot to arrive at the deployment location in a state prepared for task execution.

The deployment process ensures that robots are seamlessly integrated with the event environment through IoT connectivity, which monitors and verifies their operational status and readiness to perform assigned tasks. IoT-enabled sensors and cloud-based systems continuously track critical parameters, such as battery levels, sensor functionality, and network connectivity, while also coordinating with other devices and systems in the environment. This integration allows robots to adapt to the specific conditions of the event or job site, ensuring smooth and reliable operations.

To address environmental challenges, the method 300 may incorporate weather condition recognition and adaptation. IoT-connected weather sensors monitor external conditions, such as rainfall, wind speed, and temperature. When rain is detected, for example, the robot may activate waterproofing systems or reduce its speed to maintain stability. Similarly, in high wind conditions, the robot adjusts its posture or weight distribution to prevent tipping and ensures secure handling of cargo. These adaptive measures enable the robot to maintain performance and reliability despite changing weather conditions.

Moreover, the system 400 and method's ability to recognize irregular ground surfaces and obstacles ensures that deployment routes are dynamically updated in response to real-time data. If an obstacle is detected, the robot can be configured to recalculate its route or adjust its movement, such as slowing down or maneuvering around the hazard. This capability can be further enhanced by a self-learning AI model that continuously retrains itself on real-time data streams, improving the accuracy of obstacle detection and reducing false positives.

### Monitoring Robot Performance 370

In one embodiment, the method 300 includes a step to monitor robot performance during the event or job using AI-driven analytics. The method 300 compares real-time data streams to detect deviations or issues. In a preferred embodiment, the method 300 triggers corrective actions in response to detected anomalies.

### Providing Support Services 380

In one embodiment, the method 300 provides AI-assisted troubleshooting and predictive maintenance during the event or job. The method 300 may include a step that suggests corrective actions for detected issues. In a preferred embodiment, IoT sensor data and AI analytics are combined to prevent failures and allocate fees based on usage.

### Collecting Feedback 390

In one embodiment, the method 300 collects user feedback after the event or job and analyzes it using AI-driven processes. In some embodiments, natural language processing may be used to gauge user satisfaction. In a preferred embodiment, recurring issues or areas for improvement may be identified through AI clustering techniques.

### Refining Future Services 395

In one embodiment, the method 300 includes a step to store operational data and use AI to refine future service offerings and improve robot performance. In some embodiments, the method 300 retrains models using combined historical and current datasets. In a preferred embodiment, the method includes AI processes that continuously enhances service quality and robot capabilities.

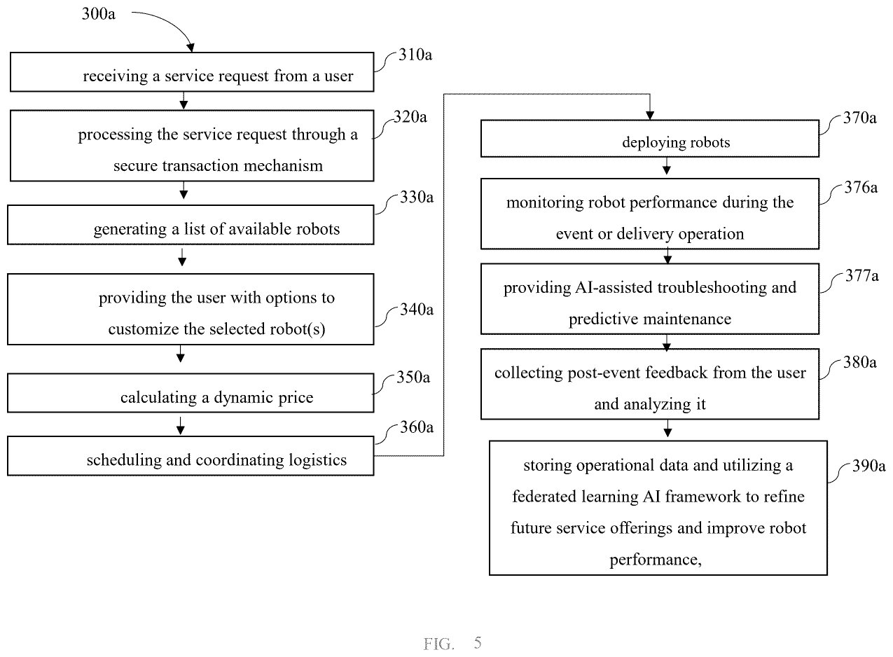

Accordingly, as shown in FIG. 5, the present invention may in one embodiment provide a method 300a comprising following steps:
receiving, via a computing device or cloud-based system, a service request from a user for robotic services at an event or delivery operation, wherein the service request includes details such as event type, location, duration, and specific robot requirements at 310a;
processing the service request through a secure transaction mechanism to ensure the integrity and confidentiality of the request, wherein the secure transaction mechanism utilizes encryption protocols, including at least Advanced Encryption Standard (AES) or Transport Layer Security (TLS) at 320a;
generating a list of available robots using an AI-based hybrid algorithm at 330a;
providing the user with options to customize the selected robot(s) for the event or delivery operation, including configuring robot appearances, behaviors, and performance routines at 340a;
calculating a dynamic price for the requested service using an AI-based pricing algorithm at 350a; and also
scheduling and coordinating logistics for deploying the selected robot(s) to the event location or job site, wherein GPS tracking ensures timely delivery of the robot(s) at 360a.

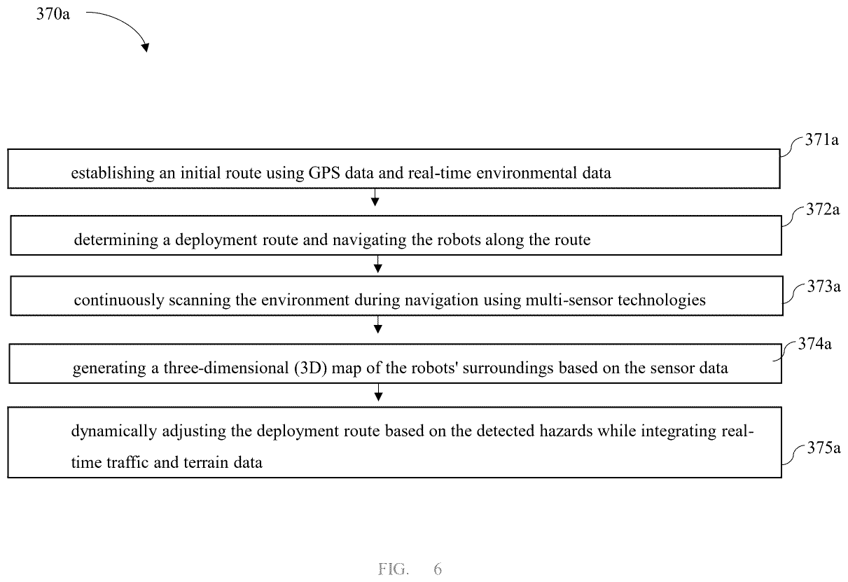

As shown in FIG. 5 and FIG. 6, the method 300a may further include a step for deploying robots at 370a. As shown in FIG. 6, the step for deploying robots at 370a may comprise steps of:
establishing an initial route using GPS data and real-time environmental data at 371a;
determining a deployment route and navigating the robots along the route at 372a;
continuously scanning the environment during navigation using multi-sensor technologies, including LiDAR, cameras, and ultrasonic sensors, to detect irregular ground surfaces, obstacles, or hazards at 373a;
generating a three-dimensional (3D) map of the robots'surroundings based on the sensor data to identify navigational hazards in real-time at 374a; and
dynamically adjusting the deployment route based on the detected hazards while integrating real-time traffic and terrain data to ensure safe and efficient navigation at 375a.

The method 300a may further include a step of monitoring robot performance during the event or delivery operation 376a using AI-driven analytics that employ a self-learning anomaly detection model, which adapts to changing operational conditions by retraining itself on real-time data streams, thereby improving the accuracy of anomaly detection and reducing false positives.

The method 300a may further include a step of providing AI-assisted troubleshooting and predictive maintenance 377a during the event or delivery operation, wherein a novel AI model predicts robot failures by analyzing IoT sensor data in combination with historical failure patterns and environmental factors, enabling proactive interventions that extend robot lifespan and reduce downtime.

In addition, the method 300a may further include a step of collecting post-event feedback from the user and analyzing it at 380a using a custom NLP model that identifies sentiment trends and correlates them with specific robot behaviors or performance metrics, enabling targeted improvements to robot programming and service offerings;

Lastly, the method 300a may further include a step of storing operational data and utilizing a federated learning AI framework to refine future service offerings and improve robot performance at 390a, wherein the system retrains models across distributed datasets without compromising data privacy, enabling continuous improvement while adhering to privacy regulations.

In some embodiment, the secure transaction mechanism may further include real-time fraud detection using machine learning models to identify anomalies in service requests. The secure transaction mechanism may utilize blockchain technology to store cryptographic hashes of service requests for enhanced traceability and tamper-proof records.

In such embodiment, the AI-based hybrid algorithm for generating the list of available robots may further incorporate real-time robot availability data to ensure accurate matching.

In such embodiment, the AI-based pricing algorithm may further incorporate predictive analytics to forecast demand and optimize pricing for competitive and fair service rates.

In such embodiment, the hybrid algorithm may combine collaborative filtering based on user preferences and content-based filtering based on robot capabilities to match robots to the service request.

In such embodiment, the AI-based pricing algorithm can be configured to analyze factors including duration, customization level, demand, and historical pricing data.

The present invention utilizes an AI-based hybrid algorithm that combines collaborative filtering, which leverages user preferences and historical data, with content-based filtering, which evaluates robot capabilities and task requirements to optimize robot selection.

The term “dynamic price” refers to a real-time price calculation based on factors such as event duration, customization level, demand, and historical pricing data.

A self-learning anomaly detection model continuously updates its parameters using real-time data streams to adapt to changing operational conditions and improve anomaly detection accuracy. The federated learning AI framework trains machine learning models across distributed datasets located on different devices or systems without centralizing data, ensuring privacy and compliance with data protection regulations.

The AI-based hybrid algorithm generates a list of available robots by integrating collaborative filtering and content-based filtering. The present invention also includes a custom NLP model trained on user feedback, such as textual reviews and sentiment data, to identify trends and correlate them with robot performance metrics.

The federated learning AI framework refines models by training on distributed datasets, such as robot performance logs and user feedback, without transferring raw data to a central server. The self-learning anomaly detection model uses reinforcement learning to adapt to real-time operational data, such as IoT sensor readings, to detect and address anomalies during robot operations.

The present invention can be implemented using well-known machine learning techniques. The AI-based hybrid algorithm may use supervised and unsupervised methods, such as k-means clustering for content-based filtering and matrix factorization for collaborative filtering. The custom NLP model may utilize transformer-based architectures, such as BERT or GPT, fine-tuned on domain-specific datasets. The federated learning AI framework can be implemented using platforms like TensorFlow Federated or PySyft to enable secure distributed training. The self-learning anomaly detection model may employ online learning techniques, such as stochastic gradient descent, to continuously update its parameters based on incoming data streams.

The secure transaction mechanism of the present invention combines Advanced Encryption Standard (AES) with blockchain technology to ensure tamper-proof logging and enhanced traceability of service requests.

In one embodiment, the present invention may also provide a system 400, as shown in FIG. 4, comprising a plurality of robots 410, a platform 420, a customization unit 430, a payment unit (model) 440, a coordination unit (model) 450, an operation unit (Event execution and monitoring tools) 460, a feedback unit (Post-event feedback mechanisms) 470, and improvement unit 480.

### Robots 410

In one embodiment, the system 400 includes a plurality of robots designed to meet diverse event and delivery needs. The system 400 of the present invention may include a catalog of robots tailored for specific applications, such as humanoid robots, drones, and service robots, each equipped with specialized features and components to

perform their respective tasks efficiently. For example, delivery robots in the system 400 may include a secure compartment or storage unit for carrying delivery items, such as packages, food, or other goods. These compartments may be temperature-controlled for sensitive items like perishable food or medical supplies. Delivery robots 410 may also be equipped with wheels or tracks for mobility, allowing them to navigate various terrains, such as sidewalks, indoor floors, or uneven outdoor surfaces.

To ensure safe and efficient operation, these robots 410 may include sensors such as LiDAR, ultrasonic sensors, infrared sensors, and cameras for obstacle detection, navigation, and mapping. Additionally, delivery robots 410 may feature wireless communication modules, such as Wi-Fi, Bluetooth, or cellular connectivity, to enable real-time communication with a central control system or user devices. These modules allow the robots to receive delivery instructions, update their location, and provide status updates to users. The robots 410 may also include onboard computers and electronic components for processing data from sensors, executing navigation algorithms, and managing delivery tasks autonomously.

In a preferred embodiment, communication between robots 410 and the system 400 occurs via secure wireless protocols (e.g., Wi-Fi, Bluetooth). In some embodiments, the catalog may include specialized robots 410, such as security robots or augmented reality (AR)-enabled robots.

### Platform 420

In one embodiment, the system 400 includes a mobile and web-based platform for browsing, selecting, and booking robots. In some embodiments, the platform 420 features an intuitive user interface, real-time availability calendar, and AI-powered recommendations. In a preferred embodiment, the platform 420 is hosted on a cloud-based server with responsive web design for scalability and reliability. In some embodiments, the platform 420 may include subscription plans or bulk booking discounts.

### Customization Unit 430

In one embodiment, the system 400 provides a unit for configuring robots 410 based on event or job requirements. In some embodiments, the customization unit 430 may include options to customize appearances, program messages, and define performance routines. In a preferred embodiment, customization data is stored in a cloud database and transmitted via encrypted channels. In some embodiments, advanced options may include AR overlays or integration with third-party APIs in the customization unit 430.

### Payment Unit 440

In one embodiment, the system 400 may include a payment unit 440 that incorporates a pricing model that adjusts based on usage, customization, and demand. In some embodiments, the payment unit 440 may include secure payment gateways (e.g., Stripe, PayPal) with multi-currency support are included.

In a preferred embodiment, the payment unit 440 may include pricing engine that uses real-time algorithms and predictive analytics.

In some embodiments, discounts for frequent users or corporate clients may be offered by the payment unit 440.

### Coordination Unit 450

In one embodiment, the system 400 includes a coordination unit 450 for scheduling and coordinating robot deployment. In some embodiments, the coordination unit 450 may feature automated scheduling, real-time GPS tracking, and IoT-enabled logistics.

In a preferred embodiment, the coordination unit 450 may include a backend system that integrates with third-party delivery services for efficiency.

In some embodiments, pre-event testing processes may be included in the coordination unit 450 to ensure robot readiness.

### Operation Unit 460

In one embodiment, the system 400 includes an operation unit 460 for monitoring robot performance and providing support during events. The operation unit 460 may perform real-time diagnostics, anomaly detection, and AI-assisted troubleshooting. In a preferred embodiment, low-latency protocols (e.g., MQTT) are used in the operation unit 460 for real-time updates.

In some embodiments, predictive maintenance features may be included in the operation unit 460 to minimize downtime.

### Feedback Unit 470

In one embodiment, the system 400 includes a feedback unit 470 for collecting and analyzing user feedback. In some embodiments, the feedback unit 470 may perform sentiment analysis, feedback clustering, and trend detection.

In a preferred embodiment, feedback unit 470 can be configured to analyze using machine learning algorithms.

### Improvement Unit 480

In one embodiment, the system 400 may include an improvement unit 480 having processes for enhancing service quality and robot performance.

In some embodiments, the improvement unit 480 may provide regular updates to the robot catalog and integration of new technologies.

In a preferred embodiment, the improvement unit 480 may include over-the-air (OTA) updates to ensure minimal disruption.

In some embodiments, beta testing programs for new features may be provided by the improvement unit 480.

### Exemplary Usage Scenario of the Present Invention 500

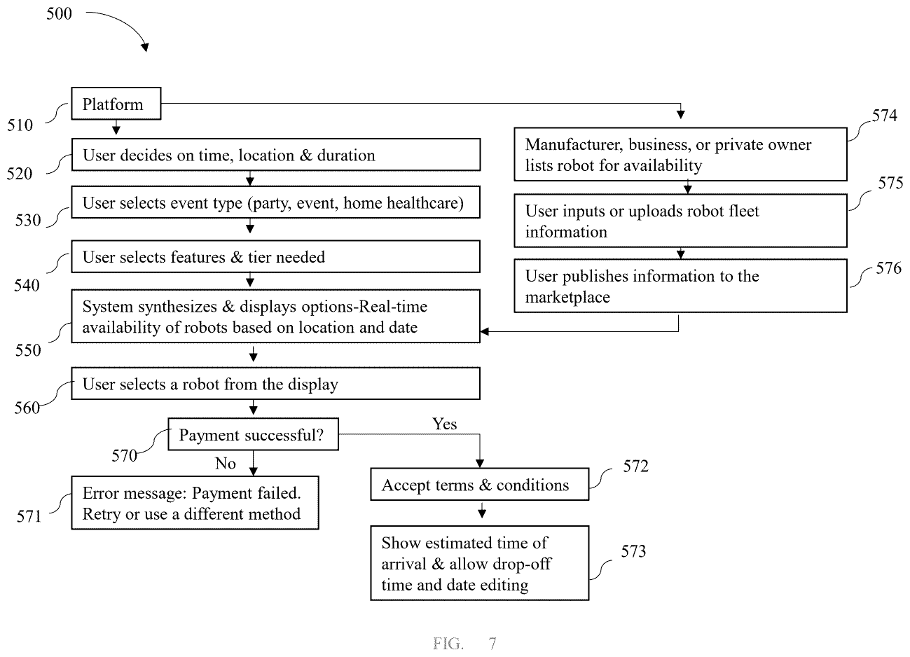

In an exemplary use scenario 500 of the present invention, as shown in FIG. 7, the method 300 and system 400 of the present invention may be represented in the following steps:

The process begins with a user accessing a marketplace or platform designed for renting robots at 510. This platform serves as a centralized hub where users can browse and select robots based on their specific requirements. At 520, the user provides key details about the intended use of the robot, including the time, location, and duration of the event. These inputs allow the system to tailor the robot selection process to the user's needs.

Subsequently, at 530, the user selects the type of event or purpose for which the robot is required, such as a party, event, or home healthcare. Based on this selection, the system filters robots to display only those suitable for the specified purpose. The user then specifies the desired features and service tier for the robot at 540, which may include automation levels, interaction capabilities, or specialized functions. The system processes the user's inputs and synthesizes real-time availability data for robots based on location, date, and other parameters at 550. The results are displayed

to the user on a desktop, mobile app, or augmented display, providing a curated list of suitable robots. The user selects a robot from the displayed options at 540 based on availability, features, and suitability for the specified event or task.

The user proceeds to payment at 570, where the system verifies the transaction. If the payment is successful, the user is prompted to accept the terms and conditions of the rental at 572. If the payment fails, the system generates an error message detailing the issue and provides the user with the option to retry or use a different payment method at 571. Upon successful payment and acceptance of terms, the system 400 provides the user with an estimated time of arrival for the robot at 573. The user may also be allowed to set a drop-off time and date, if applicable.

In another exemplary use scenario of the present invention, manufacturers, businesses, or private robot owners may utilize the system to list their robots for availability on the marketplace at 574. The robot owner accesses the platform and manually inputs or uploads detailed information about their robot fleet at 575, including specifications, features, and availability.

Once the information is entered, the robot owner publishes it to the marketplace at 576, making the robots available for users to browse and rent.

The published robot data is integrated into the system's process (AutoMatch process), ensuring that users can view and select robots based on real-time availability and suitability for their needs. This method 300 and system 400 provide a seamless process for both users renting robots and robot owners listing their robots, ensuring efficient matching, payment processing, and scheduling.

### Exemplary Use Scenario for Smart Contracts 600

In an exemplary use scenario of the present invention regarding smart contracts, the method 300 and system 400 of the present invention may be represented in the following steps:

The process begins with a user accessing a marketplace or platform designed for automation contracts at 610. At 620, the user may search for available contracts, which may include short-term, long-term, or flexible contracts. At 625, the system 400 allows the user to connect their wallet and bid on various types of contracts categorized by purpose, such as private, commercial, industrial, healthcare, or private healthcare.

At 627, the system utilizes a system process (an AutoMatch process) to synthesize and display contract options based on user preferences, location, contract type, contract category, and duration. The results are presented on a desktop, mobile app, or augmented display, enabling the user to review and decide on a contract to bid on.

Once a contract is selected, at 630, the user determines how many fulfillment slots they can commit to and places a bid. At 640, the system 400 provides the option to bid using a financial mechanism, such as a connected wallet or other payment methods. If the user wins the contract in full, they proceed to the execution phase at 641. If the user wins only a partial contract, the system adjusts the allocation accordingly at 642.

At 645, during the execution phase, the system 400 performs real-time monitoring and adjustment. Execution tracking is conducted using IoT data and performance metrics to ensure contract fulfillment. If deviations occur, such as robot malfunctions or delays, the system dynamically reallocates tasks to alternative robots. For flexible contracts, the system adjusts allocations based on real-time demand and conditions to maintain efficiency and reliability.

Upon successful completion of the contract, the user finalizes the process at 646. At 642, the system 400 incorporates a completion and feedback loop, where performance evaluation is conducted by collecting data on contract fulfillment, client satisfaction, and robot performance. Machine learning updates are applied to refine the system's matching criteria and improve future allocations. Feedback from clients and robot owners is integrated to enhance the overall process.

In another exemplary use scenario of the present invention, clients, such as companies or individuals, may utilize the system 400 to create and publish contracts on the marketplace. At 648, the client specifies detailed requirements, including robot type, capabilities, quantity, location, duration, and contract category (e.g., private, commercial, industrial, healthcare, or private healthcare). At 649, the client also sets contract types, the budget and maintenance requirements for the contract.

Once the contract details are finalized, the client publishes the contract to the marketplace at 650. The system integrates the published contracts into the AutoMatch process, ensuring that users can view and bid on contracts based on their availability and capabilities. This method 300 and system 400 provide a seamless process for both users bidding on contracts and clients creating contracts, ensuring efficient matching, execution, and feedback integration.

In the above exemplary use scenario of the present invention regarding the smart contracts, the system 400 may dynamically process multiple inputs to optimize contract fulfillment by matching available resources with client requirements in real time.

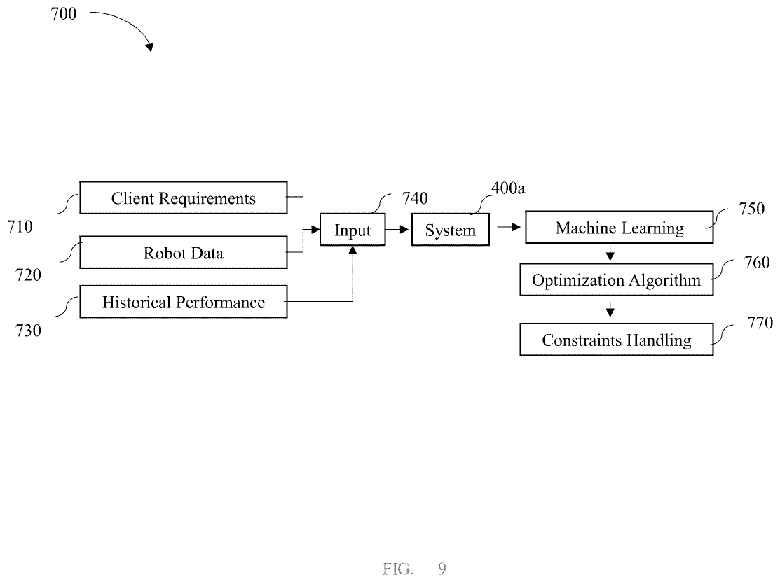

As shown in FIG. 9, the process begins with the system 400 receiving dynamic inputs from various sources. These inputs include client requirements 710, as specified in the contract, such as task objectives, timelines, and performance expectations. Additionally, the system 400 integrates robot data 720, which includes specifications, availability, location, and performance metrics of the robots available for deployment. Historical performance data 730, such as past reliability, fulfillment rates, and customer feedback, is also factored into the decision-making process. Furthermore, the system 400 may incorporate dynamic factors, such as real-time operational data and external conditions, including environmental factors, traffic conditions, or unexpected disruptions.

These inputs 740 are processed by the system 400a, which employs advanced machine learning models 750 to predict optimal matches between available robots and contract requirements. The machine learning component 750 uses supervised learning techniques to analyze historical data and predict the most suitable robots for the task. Additionally, reinforcement learning is applied to adjust strategies dynamically based on outcomes, ensuring continuous improvement in decision-making.

The system 400a then applies an optimization algorithm 760 to solve a multi-objective optimization problem. This algorithm 760 is designed to maximize efficiency, minimize costs, and ensure reliability while balancing competing priorities. For example, it may prioritize robots with higher performance metrics for critical tasks or allocate resources to minimize travel time and energy consumption.

Finally, the system 400a ensures compliance with all constraints through a constraints-handling module 770. This module verifies that the selected robots and strategies adhere to the terms of the contract, robot capacity limits, and applicable legal or regulatory requirements. By doing so, the system 400a ensures that the contract is fulfilled efficiently and in accordance with all specified conditions.

This use scenario demonstrates how the present invention dynamically integrates multiple data sources, leverages machine learning, and optimizes resource allocation to fulfill contracts in a reliable, cost-effective, and compliant manner.

### Exemplary Use Scenario for Renting Robots 800

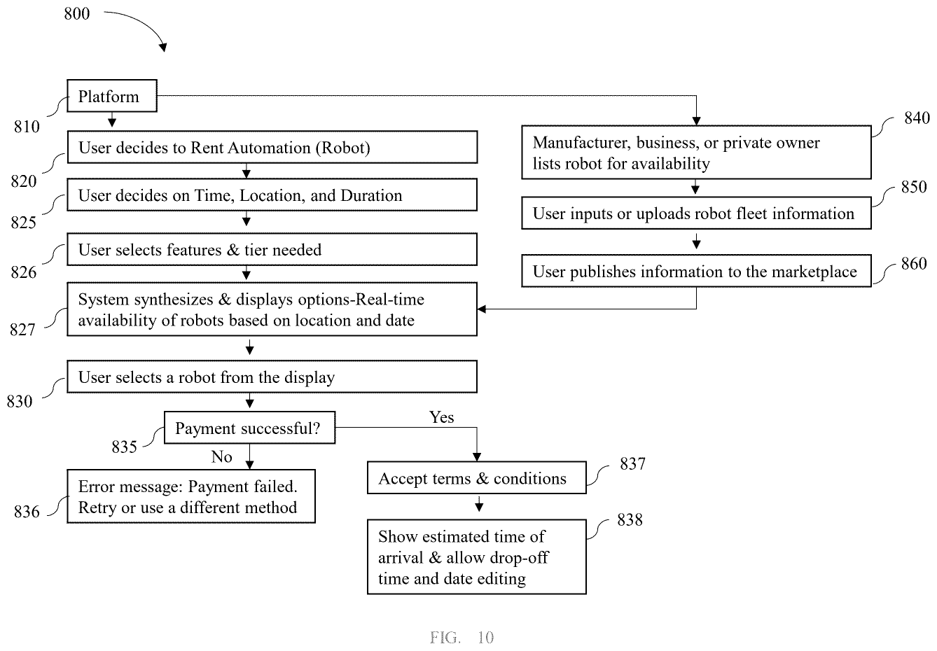

As shown in FIG. 10, in an exemplary use scenario of the present invention regarding renting robots, the method 300 and system 400 of the present invention may be represented in the following steps:

The process begins with a user accessing a marketplace or platform to rent automation, such as a robot, for a specific purpose at 810. At 820, the user may choose to rent a robot for events, parties, or private healthcare companionship from various sources, including the marketplace, direct manufacturers, hospitals, or private robot owners. At 830, the user specifies the time, location, and duration for which the robot is required, providing the system with essential parameters to tailor the selection process.

At 826, the user then selects the desired features and service tier for the robot, depending on the requirements of the task or event. This may include automation levels, interaction capabilities, or specialized functions.

At 827, the system 400 utilizes a system process (an AutoMatch process) to synthesize and display real-time availability of robots based on the user's inputs, including location, date, and other parameters. The results are presented on a desktop, mobile app, or augmented display, allowing the user to review and select a robot from the curated list at 830.

To enhance the process, the system incorporates a dynamic pricing mechanism, referred to as the System PriceOptima AI, which adjusts pricing in real-time. This system balances profitability and cost-effectiveness for all stakeholders by leveraging AI and machine learning. It considers various factors, including historical data (e.g., past transaction data, demand levels, and supply availability), stakeholder preferences (e.g., profit margins for robot owners and budget constraints for clients), market data (e.g., competitor pricing and market trends), and external factors (e.g., seasonal effects and industry-specific dynamics).

At 835, Once the user selects a robot, they proceed to payment. At 837, if the payment is successful, the user is prompted to accept the terms and conditions of the rental. Upon acceptance, at 838, the system provides the user with an estimated time of arrival for the robot and allows the user to set a drop-off time and date, if applicable. If the payment fails, at 836, the system 400 generates an error message detailing the issue and provides the user with the option to retry or use a different payment method.

In another exemplary use scenario of the present invention, manufacturers, businesses, or private robot owners may utilize the system to list their robots for availability on the marketplace at 840. The robot owner accesses the platform and manually inputs or uploads detailed information about their robot fleet at 850, including specifications, features, and availability. Once the information is entered, the robot owner publishes it to the marketplace at 860, making the robots available for users to browse and rent.

The published robot data is integrated into the system's dedicated processes (AutoMatch and PriceOptima AI processes), ensuring that users can view and select robots based on real-time availability, suitability, and dynamically optimized pricing.

This method 300 and system 400 of the present invention provide a seamless process for both users renting robots and robot owners listing their robots, ensuring efficient matching, pricing, payment processing, and scheduling.

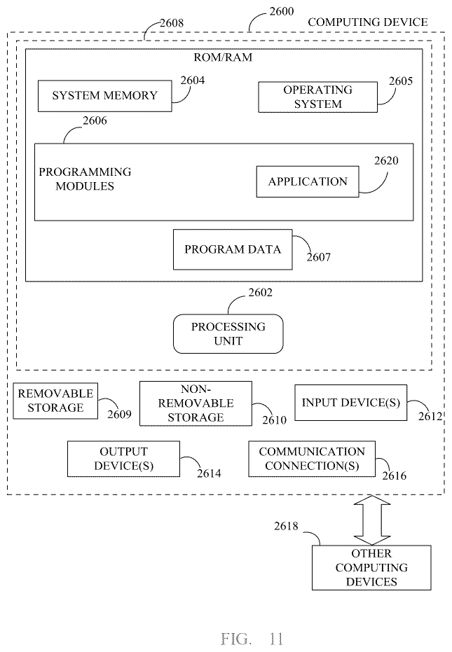

With reference to FIG. 11, a system consistent with an embodiment of the present disclosure may include a computing device or cloud-based service, such as computing device 2600. In one embodiment, computing device 2600 comprises at least one processing unit 2602 and a system memory 2604. Depending on the configuration and type of computing device, system memory 2604 may include, but is not limited to, volatile memory (e.g., random-access memory (RAM)), non-volatile memory (e.g., read-only memory (ROM)), flash memory, or any combination thereof. System memory 2604 may store an operating system 2605, one or more programming modules 2606, and program data 2607. In one embodiment, operating system 2605 is configured to control the operation of computing device 2600. Programming modules 2606 may include, for example, an image-processing module, a machine learning module, or other software components. Embodiments of the present disclosure may also be implemented in conjunction with a graphics library, other operating systems, or any other application program, and are not limited to any specific application or system. The basic configuration of computing device 2600 is illustrated in FIG. 11 by the components within dashed line 2608.

In some embodiments, computing device 2600 may include additional features or functionality. For example, computing device 2600 may include additional data storage devices, which may be removable and/or non-removable, such as magnetic disks, optical disks, or tape. These additional storage devices are illustrated in FIG. 11 as removable storage 2609 and non-removable storage 2610. Computer storage media may include volatile and non-volatile, removable and non-removable media implemented using any method or technology for storing information, such as computer-readable instructions, data structures, program modules, or other data. Examples of computer storage media include, but are not limited to, RAM, ROM, electrically erasable programmable read-only memory (EEPROM), flash memory, or other memory technologies; CD-ROM, digital versatile disks (DVD), or other optical storage; magnetic cassettes, magnetic tape, magnetic disk storage, or other magnetic storage devices; or any other medium capable of storing information and accessible by computing device 2600. In one embodiment, system memory 2604, removable storage 2609, and non-removable storage 2610 are examples of computer storage media. Any such computer storage media may be part of computing device 2600.

In one embodiment, computing device 2600 may also include input devices 2612, such as a keyboard, mouse, pen, sound input device, touch input device, location sensor, camera, biometric sensor, or other input devices. Output devices 2614, such as a display, speakers, printer, or other output devices, may also be included. The aforementioned input and output devices are examples, and other devices may also be used.

In some embodiments, computing device 2600 may include a communication connection 2616, which allows computing device 2600 to communicate with other computing devices 2618 over a network, such as an intranet or the Internet, in a distributed computing environment. Communication connection 2616 is an example of communication media. Communication media may include computer-readable instructions, data structures, program modules, or other data in a modulated data signal, such as a carrier wave or other transport mechanism, and may include any information delivery media. The term “modulated data signal” refers to a signal that has one or more characteristics set or changed in such a manner as to encode information in the signal. Examples of communication media include, but are not limited to, wired media such as a wired network or direct-wired connection, and wireless media such as acoustic, radio frequency (RF), infrared, or other wireless media. The term “computer-readable media” as used herein includes both storage media and communication media.

As described above, system memory 2604 may store a number of program modules and data files, including operating system 2605. While executing on processing unit 2602, programming modules 2606 may perform processes such as one or more stages of methods, algorithms, systems, applications, servers, or databases as described herein. For example, programming modules 2606 may include machine learning applications or other software components. The aforementioned processes are examples, and processing unit 2602 may perform other processes as well.

In general, consistent with embodiments of the present disclosure, program modules may include routines, programs, components, data structures, or other types of structures that perform particular tasks or implement particular abstract data types. Embodiments of the present disclosure may also be implemented in other computer system configurations, including handheld devices, general-purpose graphics processor-based systems, multiprocessor systems, microprocessor-based or programmable consumer electronics, application-specific integrated circuit-based systems, minicomputers, mainframe computers, and the like. In some embodiments, the present disclosure may be practiced in distributed computing environments where tasks are performed by remote processing devices linked through a communications network. In such distributed computing environments, program modules may be located in both local and remote memory storage devices.

In some embodiments, the present disclosure may also be implemented in an electrical circuit comprising discrete electronic elements, packaged or integrated electronic chips containing logic gates, a circuit utilizing a microprocessor, or a single chip containing electronic elements or microprocessors. Embodiments of the present disclosure may also be implemented using other technologies capable of performing logical operations, such as AND, OR, and NOT, including but not limited to mechanical, optical, fluidic, or quantum technologies. Additionally, embodiments of the present disclosure may be implemented within a general-purpose computer or in any other circuits or systems.

In one embodiment, the present disclosure may be implemented as a computer process (method), a computing system, or an article of manufacture, such as a computer program product or computer-readable media. The computer program product may include a computer storage medium readable by a computing system and encoding a computer program of instructions for executing a computer process. In some embodiments, the computer program product may also include a propagated signal on a carrier readable by a computing system and encoding a computer program of instructions for executing a computer process. Accordingly, embodiments of the present disclosure may be implemented in hardware and/or software (including firmware, resident software, or microcode). In other words, embodiments of the present disclosure may take the form of a computer program product on a computer-usable or computer-readable storage medium having computer-usable or computer-readable program code embodied in the medium for use by or in connection with an instruction execution system.

A computer-usable or computer-readable medium may include any medium capable of containing, storing, communicating, propagating, or transporting the program for use by or in connection with an instruction execution system, apparatus, or device. Examples of computer-readable media include, but are not limited to, electronic, magnetic, optical, electromagnetic, infrared, or semiconductor systems, apparatuses, devices, or propagation media. Specific examples of computer-readable media include, but are not limited to, an electrical connection with one or more wires, a portable computer diskette, a random-access memory (RAM), a read-only memory (ROM), an erasable programmable read-only memory (EPROM or flash memory), an optical fiber, and a portable compact disc read-only memory (CD-ROM). In some embodiments, the computer-readable medium may also include paper or another suitable medium upon which the program is printed, such that the program can be electronically captured via optical scanning or other means, compiled, interpreted, or otherwise processed in a suitable manner, and then stored in a computer memory.

While certain embodiments of the present disclosure have been described, other embodiments may also exist. Furthermore, although embodiments of the present disclosure have been described as being associated with data stored in memory or other storage media, data may also be stored on or read from other types of computer-readable media, such as secondary storage devices (e.g., hard disks, solid-state storage, USB drives), CD-ROMs, carrier waves from the Internet, or other forms of RAM or ROM. Additionally, the stages of the disclosed methods may be modified in any manner, including reordering stages and/or inserting or deleting stages, without departing from the scope of the present disclosure.

Although the invention has been explained in relation to its preferred embodiment, it is to be understood that many other possible modifications and variations can be made without departing from the spirit and scope of the invention.

What is claimed is:

1. A method comprising:
receiving, via a computing device or cloud-based system, a service request from a user for robotic services;
processing the service request through a secure transaction mechanism, wherein the secure transaction mechanism utilizes encryption protocols;
generating a list of available robots using an AI-based hybrid algorithm;
providing the user with options to customize one or more robots on the list of available robots, including configuring robot appearances, behaviors, and performance routines;
calculating a dynamic price for a requested service based on the service request using an AI-based pricing algorithm;
scheduling and coordinating logistics for deploying the one or more robots to an event location or job site;
deploying robots, comprising:
establishing an initial route using GPS data and real-time environmental data;
determining a deployment route and navigating the one or more robots along the deployment route;
continuously scanning surrounding environment during navigating the one or more robots using a plurality of sensors;
generating a three-dimensional (3D) map of surrounding environment based on sensor data from the plurality of sensors to identify navigational hazards in real-time; and
dynamically adjusting the deployment route based on detected hazards while integrating real-time traffic and terrain data to ensure safe and efficient navigation;
monitoring performance of the one or more robots during the deploying robots using AI-driven analytics that employ a self-learning anomaly detection model, which adapts to changing operational conditions by retraining itself on real-time data streams, thereby improving the accuracy of anomaly detection and reducing false positives;
providing AI-assisted troubleshooting and predictive maintenance during the deploying robots, by using an AI model that predicts robot failures by analyzing IoT sensor data in combination with historical failure patterns and environmental factors, enabling proactive interventions that extend robot lifespan and reduce downtime;
collecting post-event feedback from the user and analyzing it using a custom NLP model that identifies sentiment trends and correlates them with specific robot behaviors or performance metrics, enabling targeted improvements to robot programming and service offerings;
storing operational data and utilizing a federated learning AI framework to refine future service offerings and improve robot performance, wherein the method retrains models across distributed datasets without compromising data privacy, enabling continuous improvement while adhering to privacy regulations

2. The method of claim 1, wherein the secure transaction mechanism further includes real-time fraud detection using machine learning models to identify anomalies in service requests.

3. The method of claim 1, wherein the secure transaction mechanism utilizes blockchain technology to store cryptographic hashes of service requests for enhanced traceability and tamper-proof records.

4. The method of claim 2, wherein the AI-based hybrid algorithm for generating the list of available robots further incorporates real-time robot availability data to ensure accurate matching.

5. The method of claim 3, wherein the AI-based pricing algorithm further incorporates predictive analytics to forecast demand and optimize pricing for competitive and fair service rates.

6. The method of claim 1, wherein the hybrid algorithm combines collaborative filtering based on user preferences and content-based filtering based on robot capabilities to match robots to the service request.

7. The method of claim 1, wherein the AI-based pricing algorithm analyzes factors including duration, customization level, demand, and historical pricing data.

8. A method comprising:
receiving, via a computing device or cloud-based system, a service request from a user for robotic services;
processing the service request through a secure transaction mechanism, wherein the secure transaction mechanism utilizes encryption protocols;
generating a list of available robots using an AI-based hybrid algorithm;
providing the user with options to customize one or more robots on the list of available robots, including configuring robot appearances, behaviors, and performance routines;
calculating a dynamic price for a requested service based on the service request using an AI-based pricing algorithm;
scheduling and coordinating logistics for deploying the one or more robots to an event location or job site;
deploying robots, comprising:
establishing an initial route using GPS data and real-time environmental data;
determining a deployment route and navigating the one or more robots along the deployment route;
continuously scanning surrounding environment during navigating the one or more robots using a plurality of sensors;
generating a three-dimensional (3D) map of surrounding environment based on sensor data from the plurality of sensors to identify navigational hazards in real-time; and
dynamically adjusting the deployment route based on detected hazards while integrating real-time traffic and terrain data to ensure safe and efficient navigation;
monitoring performance of the one or more robots during the deploying robots using AI-driven analytics that employ a self-learning anomaly detection model, which adapts to changing operational conditions by retraining itself on real-time data streams, thereby improving the accuracy of anomaly detection and reducing false positives;
providing AI-assisted troubleshooting and predictive maintenance during the deploying robots, by using an AI model that predicts robot failures by analyzing IoT sensor data in combination with historical failure patterns and environmental factors, enabling proactive interventions that extend robot lifespan and reduce downtime;
collecting post-event feedback from the user and analyzing it using a custom NLP model that identifies sentiment trends and correlates them with specific robot behaviors or performance metrics, enabling targeted improvements to robot programming and service offerings;
storing operational data and utilizing a federated learning AI framework to refine future service offerings and improve robot performance, wherein the method retrains models across distributed datasets without compromising data privacy, enabling continuous improvement while adhering to privacy regulations; and
tokenizing robotic assets on a blockchain, wherein each robot in the robotic assets is represented as a unique digital token that includes metadata such as robot specifications, ownership details, and service capabilities, and wherein the blockchain includes a blockchain ledger that stores cryptographic hashes of service agreements to ensure immutability and traceability.

9. The method of claim 8, wherein the metadata in the digital token further includes robot maintenance history, operational limits, and certifications for specialized tasks.

10. The method of claim 9, wherein the blockchain ledger utilizes a distributed consensus mechanism, including at least Proof of Stake (PoS) or Proof of Authority (PoA), to ensure tamper-proof and transparent transaction records.

11. The method of claim 9, wherein the tokenized robotic assets are updated in real-time to reflect changes in robot availability, ownership, or service capabilities.

12. The method of claim 10, wherein the system further includes automated auditing functionality within the blockchain ledger to ensure compliance with regulatory requirements for robotic service agreements.

13. The method of claim 6, wherein the hybrid algorithm combines collaborative filtering based on user preferences and content-based filtering based on robot capabilities to match robots to the service request.

14. The method of claim 6, wherein the AI-based pricing algorithm analyzes factors including duration, customization level, demand, and historical pricing data.

15. A system comprising:
a computing device or cloud-based system configured to receive a service request from a user for robotic services at an event or delivery operation, wherein the service request includes details such as event type, location, duration, and specific robot requirements;
a secure transaction mechanism integrated into the system, wherein the secure transaction mechanism is configured to:
process the service request using a novel encryption protocol that combines Advanced Encryption Standard (AES) and blockchain technology;
ensure tamper-proof logging of service requests by recording transaction data on a distributed ledger; and
improve the security and traceability of transactions by preventing unauthorized modifications to the service request data.
an AI-based hybrid algorithm integrated into the system, wherein the hybrid algorithm is configured to generate a list of available robots by combining collaborative filtering based on user preferences and content-based filtering based on robot capabilities to match robots to the service request;
a user interface configured to provide the user with options to customize the selected robot(s) for the event or delivery operation, including configuring robot appearances, behaviors, and performance routines;
an AI-based pricing module configured calculate a dynamic price for the requested service using an AI-based pricing algorithm that incorporates real-time market demand, robot availability, and predictive maintenance data to optimize pricing accuracy and prevent overbooking of robotic resources;
a logistics coordination module configured to schedule and coordinate the deployment of the selected robot(s) to the event location or job site, wherein GPS tracking ensures timely delivery of the robot(s);
a deployment module configured to deploy the robot(s) to the event location or job site, wherein real-time environmental data and GPS are used to optimize deployment routes and ensure operational readiness;
an AI-driven monitoring module configured to monitor robot performance during the event or delivery operation, wherein the system detects anomalies by comparing real-time data streams with predefined performance benchmarks;
an AI-assisted troubleshooting and maintenance module configured to provide predictive maintenance and prevent robot failures during the event
or delivery operation, wherein IoT sensor data and AI analytics are combined;
a feedback analysis module configured to collect post-event feedback from the user and analyze it using natural language processing (NLP) to gauge user satisfaction and identify areas for improvement;
a data storage and refinement module configured to store operational data and utilize AI to refine future service offerings and improve robot performance, wherein the system retrains models using combined historical and current datasets; and
a blockchain-based smart contract module configured to execute smart contracts for robotic job placement and service bidding, wherein the smart contracts automatically enforce terms and conditions of the service agreement, including payment disbursement, service duration, and robot performance metrics.

16. The system of claim 15, wherein the blockchain-based smart contract module further includes functionality for automated penalty enforcement for non-compliance with service terms, such as delays or performance failures.

17. The system of claim 15, wherein the system further includes an IoT coordination module configured to integrate with IoT-connected infrastructure to ensure seamless deployment and integration of robots at the event location or job site.

18. The system of claim 15, wherein the AI-driven monitoring module is further configured to trigger automated alerts and corrective actions in response to detected anomalies in robot performance during the event.

19. The system of claim 15, wherein the system further includes diagnostic AI models configured to suggest corrective actions for detected issues and allocate fees based on robot usage.

20. The system of claim 15, wherein the system incorporates predictive analytics to forecast potential robot failures and schedule maintenance before disruptions occur.
